(19) United States
(12) Patent Application Publication
(10) Pub. No.: US 2002/0053502 A1
(43) Pub. Date: May 9, 2002

(54) Acceleration limit value switch

(75) Inventors: Heino Burmester, Heiligenhaus (DE); Ralf Burmester, Ratingen-Hosel (DE)

Correspondence Address: Edwin D. Schindler, Five Hirsch Avenue, P.O. Box 966, Coram, NY, 11727-0966, US

(73) Assignee: HELBAKO Elektronik Baugruppen GmbH & Co. KG

(21) Appl. No.: 09/880,696

(22) Filed: Jun. 12, 2001

(30) Foreign Application Priority Data
Jun. 13, 2000 (DE) 100 29 087.6.

(51) Int. Cl. H01H 35/14

(52) U.S. Cl. 200/61.45 M

(57) ABSTRACT

An acceleration limit switch includes an elastic conductive diaphragm, a printed circuit board, a permanent magnet, an alarm and a ball-shaped inertia body retained in an idle position by the permanent magnet and opposed by the elastic conductive diaphragm and the printed circuit board. The ball-shaped inertia body is placed in motion, when excited, by a sharp direction-specific change in acceleration so that the inertia body is moved from the idle position to impact the elastic conductive diaphragm for establishing a contact between conducting paths when the inertia body is received in a structure defining a hollow space so shaped for yielding a direction-selective triggering of the acceleration limit value switch for triggering the alarm.

### BACKGROUND OF THE INVENTION

1. Technical Field of the Invention

The present invention relates, generally, to an acceleration value limit switch. More particularly, the present invention relates to an acceleration limit value switch, which comprises a ball-shaped inertia body that is maintained in an idle position by a permanent magnet and opposed by an elastic, conductive diaphragm and a printed circuit board, whereby, in the case of activation or excitation, the inertia body is put into motion, impacting the diaphragm, and thereby establishes contact between relevant conducting paths.

2. Description of the Prior Art

Acceleration limit value switches are generally known to the prior art with one example being disclosed by European Patent Application No. 0,708,467. The switch disclosed in this prior art citation comprises a rotation-symmetrical inner space that is structured in the form of a hollow truncated cone at its bottom, and is cylindrical at its top. The ball-shaped inertia body is retained by a permanent magnet. Impacts acting along the horizontal line do not result in any preferred direction. The response value is exclusively dependent upon the amount of acceleration, but not on the direction of the acceleration vector.

The prior art, however, includes acceleration limit value switches in which the dependency of direction of the amount of acceleration is a required factor. For example, rescue and safety measures implemented in conjunction with motor vehicles, following an impact or in the case of a rear collision, may selectively be made dependent upon whether the impact took place from the front, the rear or from the side of the vehicle.

### SUMMARY OF THE INVENTION

It is, therefore, an object of the present invention to provide an acceleration limit value switch which is only triggered when the direction of impact is from a particular direction, i.e., dependent upon the acceleration vector.

The foregoing and related objects are achieved by the present invention, in which an acceleration limit value switch includes a ball-shaped inertia body that is retained in an idle position by a permanent magnet and which is opposed by an elastic, conductive diaphragm and a printed circuit board. In the event of excitation, or activation or impact, the inertia body is placed into motion and impacts the diaphragm, thereby establishing a contact between conducting paths. A structure defining a hollow space, which receives the inertia body, is able to effect a direction-selective triggering function by virtue of the manner in which it is shaped.

In a preferred embodiment of the present invention, the structure defining the hollow space comprises three vertical walls and an inclined, or curved, wall on which the inertia body is capable of running up, so that the inertia body is capable of running up only in the direction of the slanted wall in order to make an alarm contact, thereby triggering an alarm. Other shapes for the structure defining the hollow space of the invention would also suffice and are disclosed.

Other objects and features of the present invention will become apparent when considered in combination with the accompanying drawing figures which illustrate certain preferred embodiments of the present invention. It should, however, be noted that the accompanying drawing figures are intended to illustrate only certain embodiments of the claimed invention and are not intended as a means for defining the limits and scope of the invention.

### BRIEF DESCRIPTION OF THE DRAWING FIGURES

In the drawing, wherein similar reference numerals denote similar features throughout the several views:

FIG. 1 shows a longitudinal section through an acceleration limit value switch of the present invention, taken along the A-A line according to FIG. 2;

FIG. 2 shows is top view of the housing of the acceleration limit value switch of the present invention;

FIG. 3 shows a longitudinal section of the acceleration limit value switch taken along the B-B line of FIG. 2;

FIG. 4 is an exploded, perspective view of the acceleration limit value switch seen as inclined from above;

FIG. 5 is a corresponding view of that shown in FIG. 4 as seen from below;

FIGS. 6-10 illustrate a preferred embodiment of the acceleration limit value switch of the present invention, which differs from the embodiment illustrated in FIGS. 1-5, with the views shown in FIGS. 6-10 corresponding to those views shown in FIGS. 1-5, respectively;

FIG. 11 shows a longitudinal section of a further, preferred embodiment of the acceleration limit value switch of the present invention;

FIG. 12 shows a top view of the embodiment of the acceleration limit value switch of the present invention of FIG. 11;

FIG. 13 is a perspective view of the embodiment of the acceleration limit value switch of FIG. 11, with this view being a bottom view of that shown in FIG. 12;

FIG. 14 presents a longitudinal section through an acceleration limit value switch of the present invention for two triggering devices.

FIG. 15 shows a top view of the acceleration limit value switch of FIG. 14;

FIG. 16 is a perspective view of the acceleration limit value switch of FIGS. 14 and 15, as shown from a bottom view;

FIG. 17 is a longitudinal section through an acceleration limit value switch comprising two inertia bodies;

FIG. 18 is a top view of the acceleration limit value switch of the embodiment of the invention shown in FIG. 17;

FIG. 19 is a perspective view of the acceleration limit value switch of FIGS. 17 and 18, as shown from a bottom view;

FIG. 20 shows a longitudinal section through an acceleration limit value switch of the present invention comprising two measuring systems for different direction;

FIG. 21 shows a top view of the preferred embodiment of the acceleration limit value switch of FIG. 20; and,

FIG. 22 shows a further preferred embodiment for the acceleration limit value switch of the present invention for two opposite directions.

### DETAILED DESCRIPTION OF THE DRAWING FIGURES AND PREFERRED EMBODIMENTS

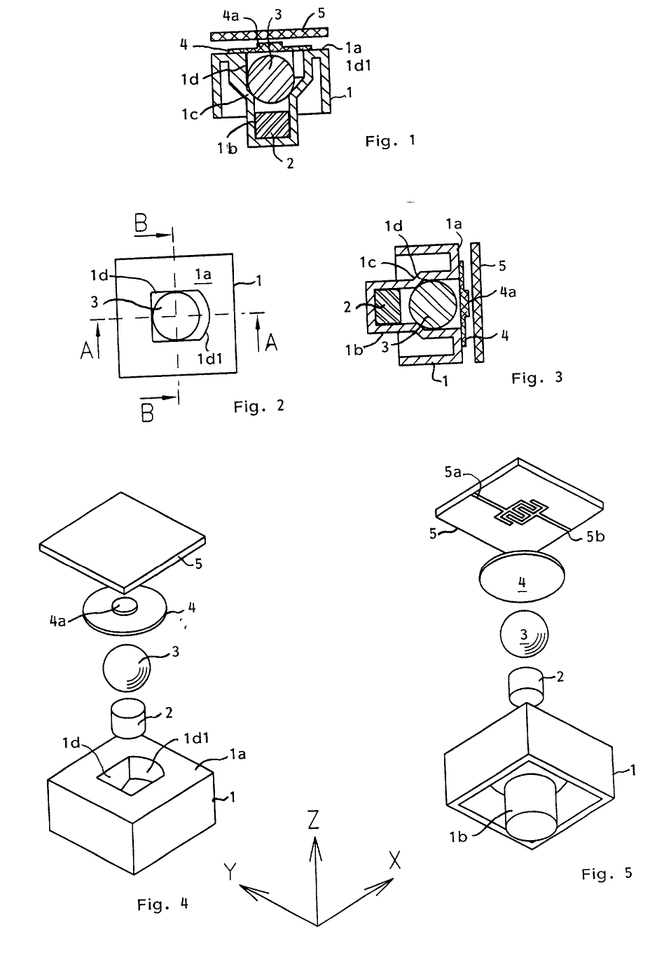

Turning now, in detail, to an analysis of the accompanying drawing figures, in FIG. 1, a housing, preferably made of plastic, is denoted by reference numeral 1. The housing comprising four side walls that change into a square board 1a. In the center area thereof, a hollow body is shaped on square board 1a by molding. The hollow body comprises, at a bottom, a cylindrical section 1b, in which a permanent magnet 2 is inserted. The cylindrical section 1b is adjoined by a zone that has the shape of a truncated cone and which changes into a predominantly rectangular hollow space 1d. An inertia body 3, which is shaped in the present embodiment in the form of a ferromagnetic ball, rests in said hollow space. Inertia body 3 is retained by permanent magnet 2. An elastic diaphragm 4 rests on square board 1a. A printed circuit board 5 is arranged on top with a slight spacing.

FIG. 2 shows a top view of the preferred embodiment of FIG. 1 without elastic diaphragm 4 or printed circuit board S. Square board 1a comprises a recess that is defined by three plane walls, which abut one another at right angles, as well as by a curved wall 1d1. The spherical inertia body 3 rests in its bearing pan formed by the truncated cone and vertical walls, so that when a lateral impact occurs, inertia body 3 can yield only in the direction of wall 1d1. In such case, inertia body 3 runs up on the conical surface until it is slowed down by diaphragm 4 and printed circuit board 5. Inertia body 3 forces a conductive, reinforced center zone 4a of diaphragm 4 against printed circuit board 5 and thereby triggers a switching pulse.

FIG. 3 shows the section along line B-B in FIG. 2. The comparison between FIGS. 1 and 3 shows that, except for the deviating wall 1d1, the components are structured in a symmetrical manner. Not shown are auxiliary constructional means that define and secure the position of diaphragm 4 and printed circuit board 5 in relation to housing 1. An O-ring is, preferably, arranged between printed circuit board 5 and housing 1; such an O-ring protecting the functional components against dust and moisture.

FIG. 4 shows an exploded view of housing 1, which comprises the hollow space defined by the walls 1d and 1d1, the cylindrically-shaped permanent magnet 2, the ball-shaped inertia body 3, the elastic diaphragm 4, and the printed circuit board 5. Diaphragm 4 may comprise a conductive elastomer material, either wholly or only in the reinforced center zone 4a.

FIG. 5 shows that housing 1 is largely hollow, starting from the bottom, except for cylindrical section 1b. The two conducting paths 5a, 5b, which mate with one another in the manner of a comb, are visible on the underside of printed circuit board 5. A control current pulse flows for a short time via said conducting paths when the switch is triggered.

The starting position is assumed, again, at the end of the acceleration impact, because the inertia body drops back into its idle position, where it is again retained by its permanent magnet.

The acceleration limit value switch responds when the impact occurs in the X-direction. An impact exactly in the -X- or Y-directions has no effect. In the presence of impacts in directions located between the X- and Y-axes, only a corresponding component of the impact contributes to triggering the switch. A switching pulse is also generated when the acceleration takes place in the direction of the Z-axis.

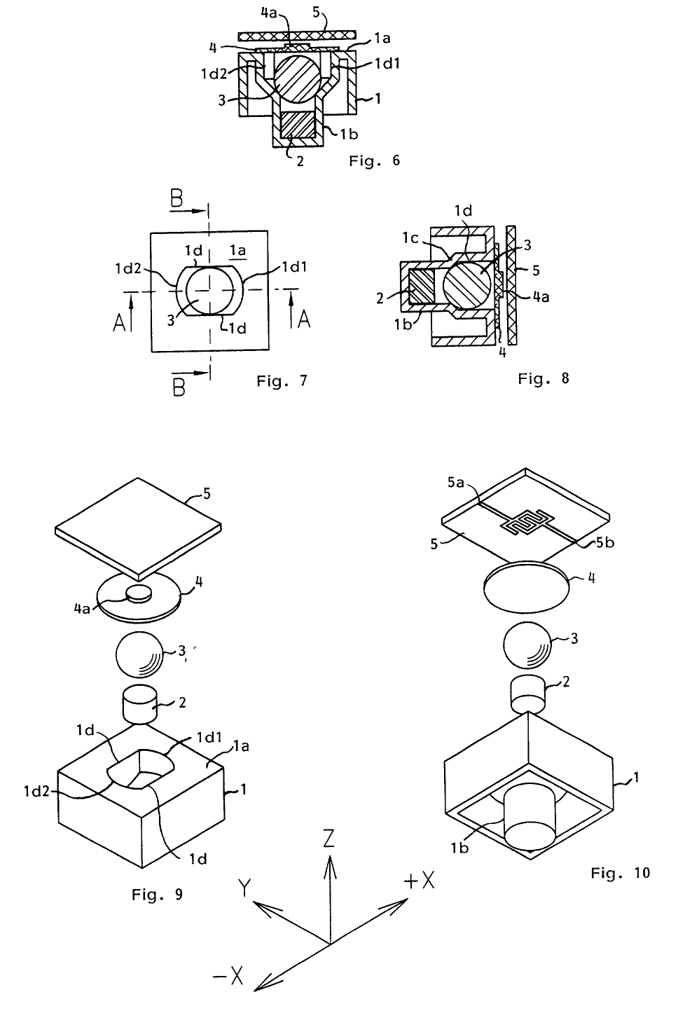

FIG. 6 shows a longitudinal section of an acceleration limit value switch that responds both with impacts in the +X- and −X-directions. Housing 1 comprises a square board 1a and, furthermore, a cylindrical section 1b. The latter is adjoined by a truncated cone 1c. Inertia body 3 rests in a hollow space id that comprises two parallel walls and the two curved walls 1d1 and 1d2. Inertia body 3 is retained by permanent magnet 2.

When an acceleration occurs in the +X- or −X-directions, the inertia body is detached from its resting position and runs either against the curved wall 1d2 or 1d1. In either case, diaphragm 4 is pressed onto printed circuit board 5 and a signal is triggered.

FIG. 7 shows that in the presence of impacts, the ball-shaped inertia body 3 is capable of performing a relative movement either to the left or to the right, such motion causing a contact to be closed. A correspondence with FIG. 3 is obvious in the section along line B-B according to FIG. 8.

FIG. 9 shows the special shape of the hollow space 1d comprising the curved walls 1d1 and 1d2. The cylindrical permanent magnet 2, the inertia body 3, the circular diaphragm 4 and the printed circuit board 5 are shown on top.

FIG. 10 shows the aforementioned components from a different perspective. The cylindrical section 1b and the conductor paths 5a, 5b are additionally visible.

FIGS. 11 to 13 show a type of construction in conjunction with which the ball-shaped inertia body is capable of moving in a slanted cylindrical tube section, which means that it reacts only to impacts occurring in a preferred direction.

The vertical section, according to FIG. 11, shows a housing 11, in conjunction with which permanent magnet 2 is fixed in a vertical cylindrical tube section 11a.

A tube section 11b having a larger diameter is attached at an angle of approximately 45°; the ball-shaped inertia body 3 rests in said tube section 11b. The top end of the tube is cut off horizontally, so that the edge 11c consequently has an elliptical shape. A diaphragm 12 is located on top of said edge, and a printed circuit board 13 is located with a slight spacing from diaphragm 12. The aforementioned angle may also strongly deviate from 45° depending upon requirements.

When an acceleration occurs in the X-direction above a limit value, inertia body 3 becomes detached from permanent magnet 2 and runs through tube section 11b against the diaphragm 12. The reinforced center area 12a then establishes a contact between the connections of the printed circuit board 13.

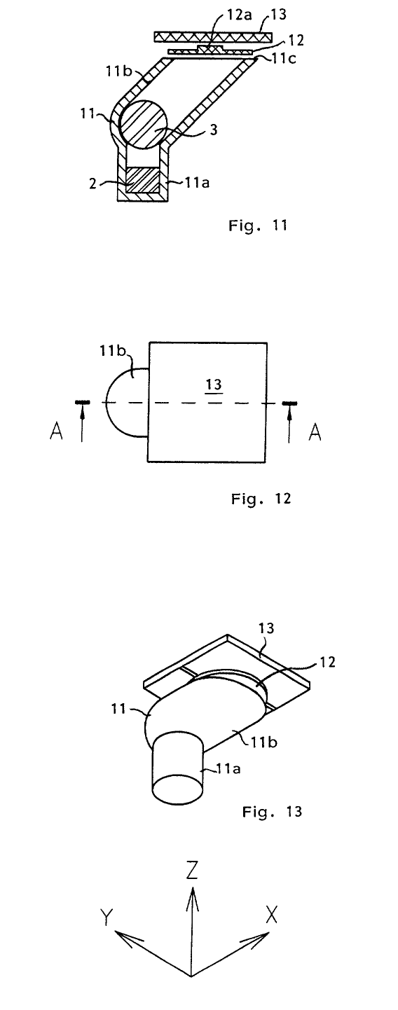

FIG. 12 represents a top view of the acceleration limit value switch. The printed circuit board 13 is arranged on top of the slanted tube section 11b.

FIG. 13 shows a perspective view of the acceleration limit value switch of FIG. 12 from the bottom. Components 11 through 13 are kept together by an outer housing (not shown) and are protected against external influences.

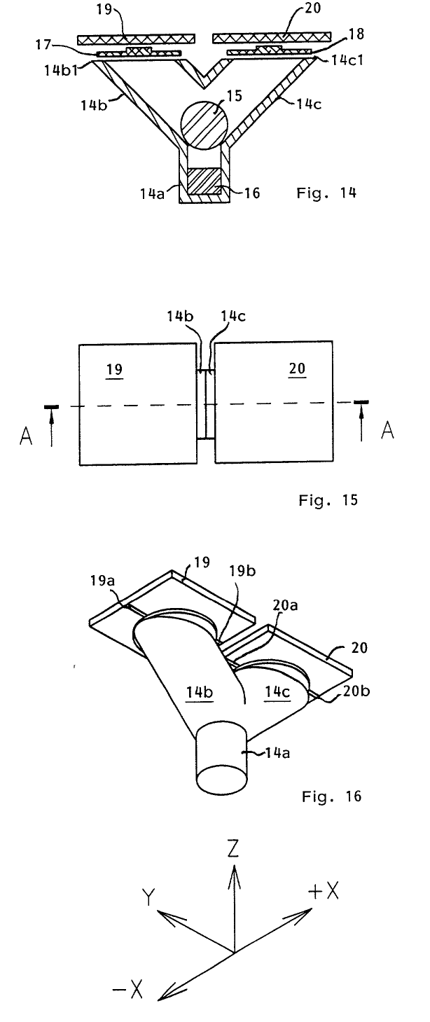

FIGS. 14 through 16 show a variation of the foregoing acceleration limit value switch comprising an inertia body and two contact sensors.

The longitudinal section, according to FIG. 14, shows that a cylindrical section 14a changes into two tubes 14b, 14c in the manner of a Y-tube; the diameter of said two tubes is adapted to the size of the ball-shaped inertia body 15. Inertia body 15 is retained in a central position by a cylindrical permanent magnet 16.

The tubes 14b and 14c are cut off horizontally at the top, so that two elliptic edge surfaces 14b1 and 14c1 are produced. The elastic diaphragms 17, 18 rest on said surfaces and are opposed by printed circuit boards 19, 20, respectively.

FIG. 15 shows the preferred embodiment of FIG. 14 from a top view. Short sections of tubes 14b, 14c can be seen between the printed circuit boards 19, 20.

FIG. 16 represents a perspective view of the preferred embodiment of FIG. 14 from a bottom view. In FIG. 16, tubes 14a, 14b, 14c are shown as merging one into another. The diaphragms 17, 18 and printed circuit boards 19, 20 are located on top. The ends of the conducting paths are denoted by reference symbols 19a, 19b and 20a, 20b.

When an impact occurs in the +X-direction, a pulse contact is made on printed circuit board 19 when the limit value is exceeded. An impact in the −X-direction excites the system 18, 20.

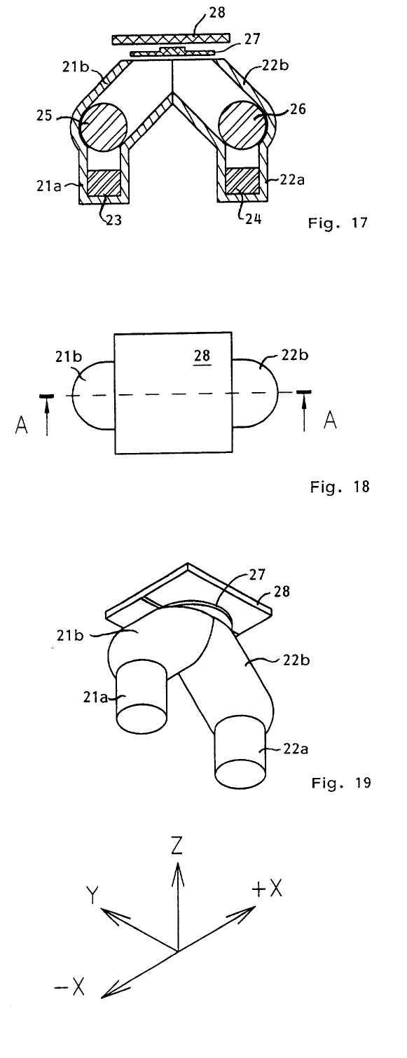

Another embodiment of the present invention, according to FIGS. 17 through 19, shows an acceleration limit value switch comprising two inertia bodies, a diaphragm and a printed circuit board.

The vertical section according to FIG. 17 shows that a cylindrical tube 21a changes into a larger tube 21b that is slanted to the right. Another cylindrical tube 22a is attached to a tube 22b that is slanted to the left. The permanent magnets 23, 24 are inserted in the tubes 21a, 22a, said permanent magnets retaining the inertia bodies 25, 26. The tubes 21b, 22b are united in the plane of symmetry C-C. The hollow space is terminated upwards by an elastic, conductive diaphragm 27. A printed circuit board 28 is located on top. The diaphragm and the printed circuit board are secured on the other components in an exact and sealing manner.

FIG. 18 shows a top view of the rectangular printed circuit board 28, to which the slanted tubes 21b, 22b run up to.

FIG. 19 presents a perspective view of the same embodiment from a bottom view. The tubes 21a, 21b, as well as tubes 22a, 22b are connected with each other by elbow-shaped transition zones. The conductive diaphragm 27 and the printed circuit board 28 are located above the tubes.

When an adequately forceful acceleration occurs in the +X-direction, inertia body 25 is detached from the magnet 23 and rolls against diaphragm 27, making contact. In the presence of an acceleration in the −X-direction, the inertia body 26 triggers a pulse contact.

When impacts occurs in the Y-direction, no excitation takes place. When impacts occur from other directions, a component of the acceleration forces acts in the excitation direction +X or −X.

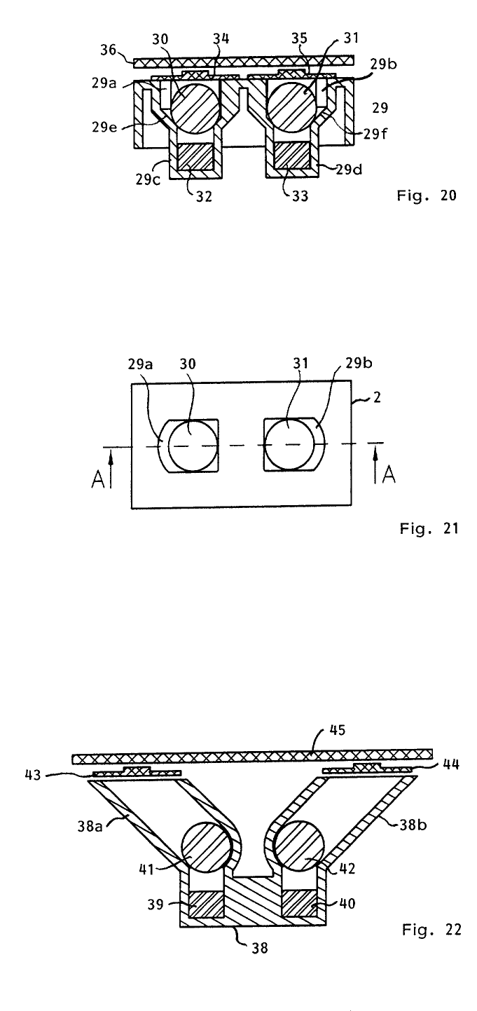

FIG. 20 shows a longitudinal section through an acceleration limit value switch equipped with two systems. A housing 29 having the shape of a cube comprises the two recesses 29a, 29b disposed next to one another, with the ball-shaped inertia bodies 30, 31 resting in said recesses. Inertia bodies 29, 30, which are comprised of ferromagnetic material, are retained by the permanent magnets 32, 33 that are pressed into the cylindrical outward bulges 29c, 29d of housing 29. Conductive diaphragms 34, 35 are located above inertia bodies 30, 31 and are opposed by a printed circuit board 36 comprising two contact systems; said printed circuit board being slightly spaced from said diaphragms. The configuration of the conducting paths corresponds with that illustrated in FIG. 5.

FIG. 21 is a top view of housing 29 after diaphragms 34, 35 have been removed. Inertia bodies 30, 31 are received in the asymmetrical recesses 29a, 29b. Three wall elements are each planar and a fourth one is curved. In the presence of an adequately forceful horizontal impact, either inertia body 30 or inertia body 31 is capable of responding, in which case it becomes detached from its idle position, rolls up the slanted surface 29e, 29f, impacts the diaphragm, and triggers a pulse contact.

When the acceleration limit value switch, for example, as a component of a motor vehicle, moves in the direction indicated by arrow 37, and is suddenly slowed down, inertia body 31 triggers a contact. If the motor vehicle is impacted from the rear, inertia body 30 makes contact.

In a further, preferred embodiment of the present invention, the acceleration limit value switch comprises two measuring systems, as shown in FIG. 22. This Figure shows a housing 38 comprising two permanent magnets 39, 40 and two ball-shaped inertia bodies 41, 42, which are supported in the inclined tube sections 38a, 38b. The tubes are cut off horizontally at the top, so that the elliptic openings 38c, 38d are formed. The conductive diaphragms 43, 44 are seated on said openings. A stretched-out printed circuit board 45 is mounted on top and equipped with two contact systems in a manner analogous to that shown in FIG. 5. The function is the same as with the embodiment illustrated in FIGS. 20 and 21.

Acceleration limit value switches comprising two independent measuring systems offer the substantial advantage that they can serve for clarifying the question of who is at fault in road traffic accidents involving a number of rear-end collisions. If the pulse contacts are separately detected in an electronic evaluation device, it can be clearly determined, after an accident of the foregoing type, whether a motor vehicle first rear-ended a vehicle driving in front of it and was subsequently hit from behind, or whether a third-party first collided with the rear end and thereby pushed the vehicle against one being driven in front of it.

It is finally pointed out that the accompanying drawings represent only the construction and functional principles of the acceleration limit value switch of the present invention. When translated into practical application, the housings are, of course, designed so that they comprise holding means and sealing elements for the diaphragm and printed circuit boards. Preferably, O-rings are used as the requisite sealing elements. The interior spaces accommodating the magnets and the inertia bodies are, consequently, permanently protected against any penetration of dust and moisture.

While only several embodiments of the present invention have been shown and described, it will be obvious to those skilled in the art that many modifications may be made to the present invention without departing from the spirit and scope thereof.

### LIST OF REFERENCE NUMERALS

1—housing

1a—square board

1b—cylindrical section

1c—truncated cone-shaped zone

1d—rectangular hollow space

1d1, 1d2—curved walls

2—permanent magnet

3—inertia body

4—elastic diaphragm

4a—reinforced center area

5—printed circuit board

5a, 5b—conducting paths

11—housing

11a—cylindrical section

11b—tube section

11c—elliptic edge

12—diaphragm

12a—center area

13—printed circuit board

14a—cylindrical section

14b, 14c—tube sections

14b1, 14b2—elliptic edge surfaces

15 —inertia body

16 —permanent magnet

17, 18—diaphragm

### LIST OF REFERENCE NUMERALS (continued)

19, 20—printed circuit boards

21a, 22a—cylindrical tubes

21b, 22b—inclined tubes

23, 24—magnets

25, 26—inertia bodies

27—diaphragm

28—printed circuit board

29—housing

29a, 29b—recesses

29c, 29d—cylindrical bulges

30, 31—inertia bodies

32, 33—permanent magnets

34, 35—conductive diaphragms

36—printed circuit board

37—arrow

38—housing

37a, 38b—tube sections

38c, 38d—elliptic openings

39, 40—permanent magnets

41, 42—inertia bodies

43, 44—diaphragms

45—printed circuit board

What is claimed is:

1. An acceleration limit switch, comprising:
an elastic conductive diaphragm;
a printed circuit board;
a permanent magnet;
an alarm; and,
a ball-shaped inertia body retained in an idle position by said permanent magnet and opposed by said elastic conductive diaphragm and said printed circuit board, said ball-shaped inertia body being placed in motion when excited by a sharp direction-specific change in acceleration so that said ball-shaped inertia body is placed in motion from said idle position to impact said elastic conductive diaphragm for establishing a contact between conducting paths when said ball-shaped inertia body is received in a structure defining a hollow space so shaped for yielding a direction-selective triggering of said acceleration limit value switch to thereby trigger said alarm.

2. The acceleration limit value switch according to claim 1, wherein said structure defining said hollow space comprises three vertical walls and an inclined, or curved, wall on which said ball-shaped inertia body is capable of running up, so that only an impact creating the sharp direction-specific change in acceleration is effective for triggering said alarm.

3. The acceleration limit value switch according to claim 1, wherein said structure defining said hollow space comprises two vertical walls and two inclined, or curved, walls, so that only an impact creating the sharp direction-specific change in acceleration, in two possible directions, is effective for triggering said alarm.

4. The acceleration limit value switch according to claim 1, wherein said structure defining said hollow space is located above said ball-shaped inertia body in an inclined tubular section that terminates at a top end by said elastic conductive diaphragm and said printed circuit board, so that only an impact creating the sharp direction-specific change in acceleration is effective for triggering said alarm.

5. The acceleration limit value switch according to claim 4, wherein two of said inclined tubular sections are offset from one another by 180° in a housing, and two of said permanent magnets, two of said ball-shaped inertia bodies, two of said elastic conductive diaphragms and one of said printed circuit boards are joined for separately detecting impacts in opposite directions.

6. The acceleration limit value switch according to claim 1, wherein said structure defining said hollow space is located above said ball-shaped inertia body and is formed by two inclined tubular sections which terminate upwards by two of said elastic conductive diaphragms and two of said printed circuit boards, so that only an impact creating the sharp direction-specific change in acceleration, in two possible directions, is effective for triggering said alarm, there being a separate contact for each of said two possible directions for triggering said alarm.

7. The acceleration limit value switch according to claim 1, further comprising two cylindrical tubular sections, each of said two cylindrical tubular sections having one said permanent magnet and one said ball-shaped inertia body, so that said structure forming said hollow space, located above said ball-shaped inertia bodies, is formed by two inclined, merging tube sections, and terminates at a top end of said elastic conductive diaphragm and said printed circuit board, so that only an impact creating the sharp direction-specific change in acceleration, in two possible directions, is effective for triggering said alarm, there being a respective said permanent magnet and a respective said ball-shaped inertia body for each of said two possible directions for triggering said alarm.

8. The acceleration limit value switch according to claim 2, further comprising two cylindrical tubular sections, each of said two cylindrical tubular sections having one said permanent magnet and one said ball-shaped inertia body, so that said structure forming said hollow space, located above said ball-shaped inertia bodies, is formed by two inclined, merging tube sections, and terminates at a top end of said elastic conductive diaphragm and said printed circuit board, so that only an impact creating the sharp direction-specific change in acceleration, in two possible directions, is effective for triggering said alarm, there being a respective said permanent magnet and a respective said ball-shaped inertia body for each of said two possible directions for triggering said alarm.
